(19) United States
(12) Patent Application Publication
(10) Pub. No.: US 2025/0365117 A1
(43) Pub. Date: Nov. 27, 2025

(54) COMMUNICATION APPARATUS, CONTROL METHOD, AND RECORDING MEDIUM

(71) Applicant: CANON KABUSHIKI KAISHA, Tokyo (JP)

(72) Inventor: MASATOMO OUCHI, Tokyo (JP)

(21) Appl. No.: 19/287,220

(22) Filed: Jul. 31, 2025

Related U.S. Application Data
(63) Continuation of application No. PCT/JP2024/002626, filed on Jan. 29, 2024.

(30) Foreign Application Priority Data
Feb. 3, 2023 (JP) 2023-015590

(51) Int. Cl. H04L 5/00; H04W 8/22; H04W 84/12

(52) U.S. Cl. CPC H04L 5/0053; H04L 5/0078; H04W 8/22; H04W 84/12

(57) ABSTRACT

A communication apparatus which communicates with a first other communication apparatus and a second other communication apparatus, the communication apparatus performing operations including performing first settings to receive data in collaboration with the first other communication apparatus, performing second settings with the second other communication apparatus to transmit a Block Acknowledgment (BA) at a delayed timing, transmitting, in a case where at least part of first data transmitted from the second other communication apparatus is received, an Acknowledgment (Ack) to the second other communication apparatus; and transmitting, in a case where at least part of the first data received by the first other communication apparatus is received from the first other communication apparatus, the BA to the second other communication apparatus after transmitting of the Ack.

### CROSS-REFERENCE TO RELATED APPLICATIONS

This application is a Continuation of International Patent Application No. PCT/JP2024/002626, filed Jan. 29, 2024, which claims the benefit of Japanese Patent Application No. 2023-015590, filed Feb. 3, 2023, both of which are hereby incorporated by reference herein in their entirety.

### BACKGROUND

### Field of the Technology

The present disclosure relates to a communication apparatus conforming to the Institute of Electrical and Electronics Engineers (IEEE)802.11 standard.

### Description of the Related Art

The IEEE802.11 series standard is known as a communication standard related to Wireless Local Area Networks (hereinafter referred to as WLANs). U.S. Patent Application Publication No. 2021/0211375 describes a method for implementing, in addition to high-peak-throughput, low-delay communication by using the Multi-Link technique.

Japanese Patent Laid-Open No. 2020-141300 describes a method in which transmit data for a single station (STA) is assigned to a plurality of access points (APs) spatially dispersedly disposed, and the APs parallelly transmit the data to the STA to improve the throughput.

A configuration in which a plurality of APs collaboratively receives data transmitted from a single STA has also been studied.

In the configuration in which a plurality of APs collaboratively receive data, there can be a case in which, if a conventional one-to-one communication method is used, an appropriate communication becomes incapable of being performed.

### SUMMARY

In view of the above-described issue, the present disclosure is directed to providing a method for appropriately performing communication processing even in a case where a plurality of communication apparatuses collaboratively performs data communication.

According to an aspect of the present disclosure, a communication apparatus which communicates with a first other communication apparatus and a second other communication apparatus, the communication apparatus including one or more memories that store a set of instructions, and at least one processing circuit, wherein the communication apparatus is caused, by the at least one processing circuit executing the instructions and/or the at least one processing circuit itself operating, to perform operations including performing first settings to receive data in collaboration with the first other communication apparatus, performing second settings with the second other communication apparatus to transmit a Block Acknowledgment (BA) at a delayed timing, transmitting, in a case where at least part of first data transmitted from the second other communication apparatus is received, an Acknowledgment (Ack) to the second other communication apparatus; and transmitting, in a case where at least part of the first data received by the first other communication apparatus is received from the first other communication apparatus, the BA to the second other communication apparatus after transmitting of the Ack.

Features of the present disclosure will become apparent from the following description of embodiments with reference to the attached drawings.

### BRIEF DESCRIPTION OF THE DRAWINGS

FIG. 1 is a diagram illustrating a system configuration.

FIG. 2 is a diagram illustrating an apparatus configuration (hardware configuration) according to an embodiment.

FIG. 3 is a diagram illustrating a function configuration (software configuration) according to the present embodiment.

FIG. 4A is a sequence diagram illustrating a setting up procedure for access point (AP) cooperative communication according to a first embodiment.

FIG. 4B is a sequence diagram illustrating a procedure for data transmission from a station (STA) to access points (AP) according to the first embodiment.

FIG. 5 is a diagram illustrating a Media Access Control (MAC) frame structure.

FIG. 6 is a diagram illustrating an HT Capabilities element structure.

FIG. 7A is a diagram illustrating a MAC frame format.

FIG. 7B is a diagram illustrating an Action frame structure.

FIG. 7C is a diagram illustrating types and values of an Action category.

FIG. 8A is a diagram illustrating an Action frame structure.

FIG. 8B is a diagram illustrating an Action related to a Multi AP.

FIG. 9A is a diagram illustrating an Action frame structure.

FIG. 9B is a diagram illustrating an Action related to a Block Acknowledgment (Ack).

FIG. 9C is a diagram illustrating contents of an Add Block Ack (ADDBA) Request.

FIG. 9D is a diagram illustrating contents of an ADDBA Response.

FIG. 9E is a diagram illustrating the contents of a Block Ack Parameter Set.

FIG. 10A is a diagram illustrating a MAC frame format.

FIG. 10B is a diagram illustrating a Block Ack (BA) frame structure.

FIG. 10C is a diagram illustrating contents of a BA Information field.

FIGS. 11A and 11B is a flowchart illustrating processing of a Master AP.

FIG. 12 is a sequence diagram according to a second embodiment of the present disclosure.

### DESCRIPTION OF THE EMBODIMENTS

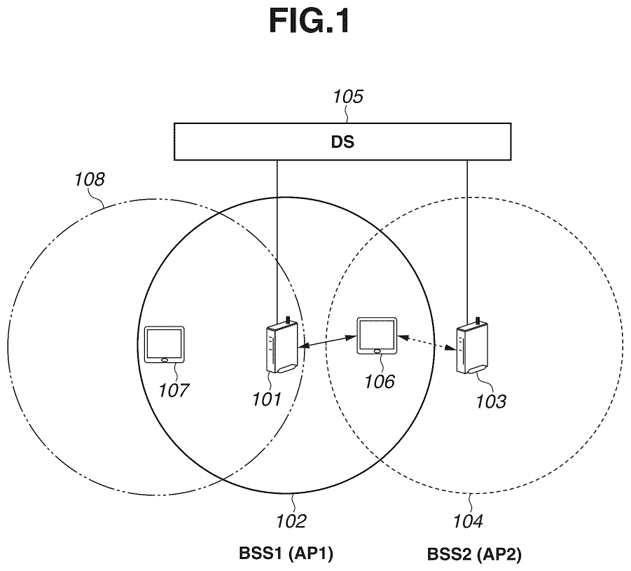

A system according to a present embodiment will be described below with reference to FIG. 1. FIG. 1 is a diagram illustrating an access point (AP) 1 101, and a region 102 schematically representing coverage of the electric wave of the AP1. A network formed by an AP may be referred to as a Basic Service Set (BSS). The AP1 101 configures a BSS1. FIG. 1 illustrates an AP2 103 different from the AP1 101, and a region 104 schematically representing coverage of the electric wave of the AP2 103. The AP2 103 configures a BSS2.

A Distribution System (DS) 105 extends the connection of each BSS. This may be referred to as Backhaul. The AP1 101 and the AP2 103 are connected with another BSS or an external network via the DS 105. Examples of the connection methods include wired communications, such as Ethernet® and telephone lines, wireless communications, such as Long-Term Evolution (LTE) and Worldwide Interoperability for Microwave Access (WiMAX), and wireless WLAN conforming to the Instituted of Electrical and Electronics Engineers (IEEE)802.11 standard. In this case, the connection between an AP and the other BSS or the external network may be similar to or different from a wireless channel used between the AP and a terminal. The AP1 101 and the AP2 103 can connect and collaboratively communicate data with each other via the DS 105.

A station terminal (STA) 106 is connected with the AP1 101. Although the AP2 103 exists within the coverage of the STA 106, the STA 106 is not connected with the AP2 103.

A terminal 107 serves as an interference source that affects data reception of the AP1 101. The terminal 107 may not conform to the IEEE802.11 standard, and may not even be a communication terminal in the meaning that the terminal 107 cannot be controlled by the AP1 101. An interference range 108 indicates a range that is affected by the electric wave of the terminal 107.

The AP1 101 and the AP2 103 are configured to perform wireless frame communication conforming to the successor standard of the IEEE802.11be standard aiming for a maximum transmission rate of 46.08 gigabits per seconds (Gbps) and aiming for a maximum transmission rate exceeding 90 to 100 Gbps. The STA 106 is also configured to perform wireless frame communication conforming to the successor standard.

The successor standard of the IEEE802.11be standard is characterized mainly in the support of high-reliability low-latency communication and AP collaboration. In view of the above descriptions, the successor standard of the IEEE802.11be standard aiming for a maximum transmission rate exceeding 90 to 100 Gbps is also referred to as the IEEE802.11 Ultra High Reliability (UHR) standard in the present embodiment. A wireless frame communicated through the relevant successor standard is also referred to as UHR PPDU. PPDU is an abbreviation for PLCP Protocol Data Unit. PLCP is an abbreviation for Physical Layer Convergence Protocol.

The name of the IEEE802.11UHR standard is conveniently provided in consideration of the target to be achieved by the successor standard and the features of the relevant standard. The name may be changed in a state where the standard has been established. The present specification and the appended claims are inherently applicable to all of successor standards of the IEEE802.11be standard that supports a function of performing processing in which a plurality of APs collaboratively receive data from the STA 106.

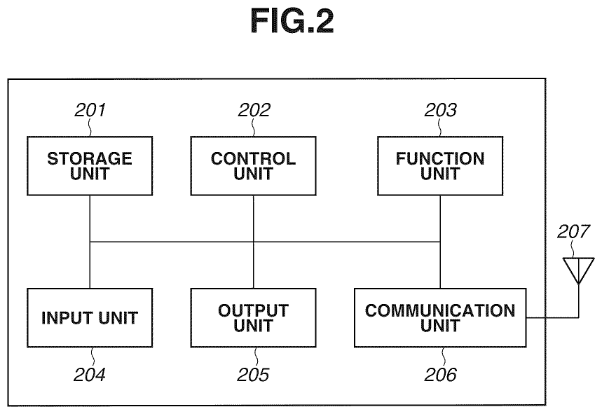

FIG. 2 is a diagram illustrating a hardware configuration commonly applicable to the AP1 101, the AP2 103, and the STA 106 (non-AP terminal) according to the present embodiment. For example, the hardware configuration includes a storage unit 201, a control unit 202, a function unit 203, an input unit 204, an output unit 205, a communication unit 206, and an antenna 207.

The storage unit 201 includes memories, such as a Read Only Memory (ROM) and a Random Access Memory (RAM), and stores programs for various operations (described below) and various information, such as communication parameters for wireless communications. Storage media applicable as the storage unit 201 include not only the ROM and RAM but also a flexible disk, hard disk, optical disk, magneto-optical disk, compact disc read only memory (CD-ROM), compact disc recordable (CD-R), magnetic tape, nonvolatile memory card, and digital versatile disc (DVD). The storage unit 201 may also include a plurality of memories.

The control unit 202 includes, for example, processors such as a Central Processing Unit (CPU) and Micro Processing Unit (MPU), Application Specific Integrated Circuit (ASIC), Digital Signal Processor (DSP), and Field Programmable Gate Array (FPGA). The CPU executes programs stored in the storage unit 201 to control the AP1 101 and the AP2 103. The control unit 202 may control the AP1 101 and the AP2 103 through the collaboration between programs stored in the storage unit 201 and an Operating System (OS). The control unit 202 may include a plurality of processors, such as multi-core processors, to control the AP1 101 and the AP2 103. The control unit 202 controls the function unit 203 to perform predetermined processing, such as AP functions, STA functions, imaging, printing, and projection.

The function unit 203 is a hardware component that is used by the APs or STA to perform predetermined processing. For example, in a case where the function unit 203 is a printer, the function unit 203 prints image data acquired via the communication unit 206. In a case where the function unit 203 is a scanner, the function unit 203 transmits image data generated by the scanner to an external apparatus via the communication unit 206. In a case where the function unit 203 is a camera, the function unit 203 transmits image data captured by the camera to an external apparatus via the communication unit 206.

The input unit 204 receives various operations from the user. The input unit 204 includes, for example, a touch panel, hardware keys, and buttons.

The output unit 205 provides the user with various outputs. Outputs by the output unit 205 include at least one of display on a screen, sound output by a speaker, and vibration output. Both the input unit 204 and the output unit 205 may be implemented by a single module, such as a touch panel.

The communication unit 206 controls wireless communication conforming to the IEEE802.11 standard, wireless communication conforming to Wi-Fix, and Internet Protocol (IP) communication. The communication unit 206 further controls the antenna 207 to transmit and receive wireless signals for wireless communications. The communication unit 206 may be configured to perform Near Field Communication (NFC) and Bluetooth® communications.

Although FIG. 2 illustrates one antenna (antenna 207) for simplification, the system may have a plurality of antennas. Generally, the number of antennas corresponds to the number of Spatial Streams. The number of communication units 206 and the number of antennas 207 correspond to the number of supported streams corresponding to the supported frequency bands (2.4 Gigahertz (GHz), 5 GHZ, and 6 GHz bands).

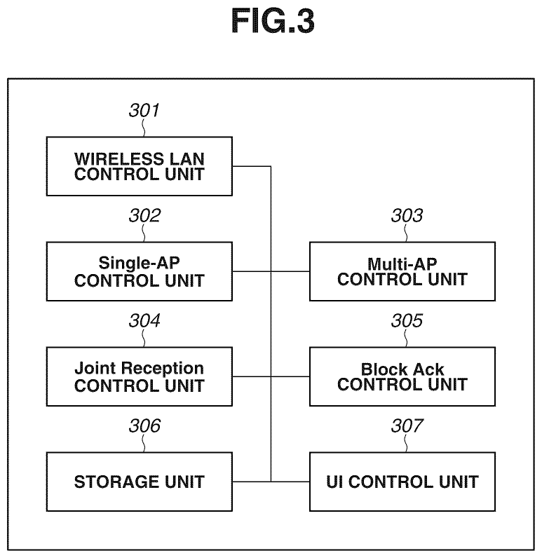

FIG. 3 is a diagram illustrating an example of the AP or STA function (software) configuration. For example, the function configuration includes a wireless LAN control unit 301, a Single-AP control unit 302, a Multi-AP control unit 303, a Joint Reception control unit 304, a Block Acknowledgment (Ack) control unit 305, a storage unit 306, and a user interface (UI) control unit 307.

The wireless LAN control unit 301 includes circuits for transmitting and receiving wireless signals with other wireless LAN apparatuses (e.g., the other AP and STA) and programs for controlling these circuits. The wireless LAN control unit 301 is configured to control frame generation, frame transmission, wireless frame reception from other wireless LAN apparatuses, and other wireless LAN communications conforming to the IEEE802.11 series standard.

The Single-AP control unit 302 is a function unit for controlling an AP to operate independently from the other AP.

The Multi-AP control unit 303 controls synchronous and collaborative operations with the other AP. An AP performs setting processing with the other AP to collaborate with the other AP. The Joint Reception control unit 304 is a function unit for performing data reception in collaboration with the other AP. Joint Reception refers to processing in which a plurality of communication apparatuses collaboratively receives data from an opposed apparatus, and the data received by the plurality of communication apparatuses is integrated into one piece of data.

The Block Ack (BA) control unit 305 controls BA communication. The BA control unit 305 also controls the transmission of a Block Acknowledgment frame and other procedures in collaboration with the Joint Reception control unit 304. A Block Acknowledgment is referred to as a Block Ack or BA.

The storage unit 306 includes storage devices, such as a Read Only Memory (ROM) or Random Access Memory (RAM), for storing programs to be executed by the AP1 101, the AP2 103, and the STA 106 and various data.

The UI control unit 307 includes hardware components related to user interfaces (UIs), such as a touch panel and buttons, for receiving operations on the AP1 101, the AP2 103, and the STA 106 by their users, and programs for controlling these components. The UI control unit 307 also includes a function of presenting information to the user, such as image display and sound output.

### First Embodiment

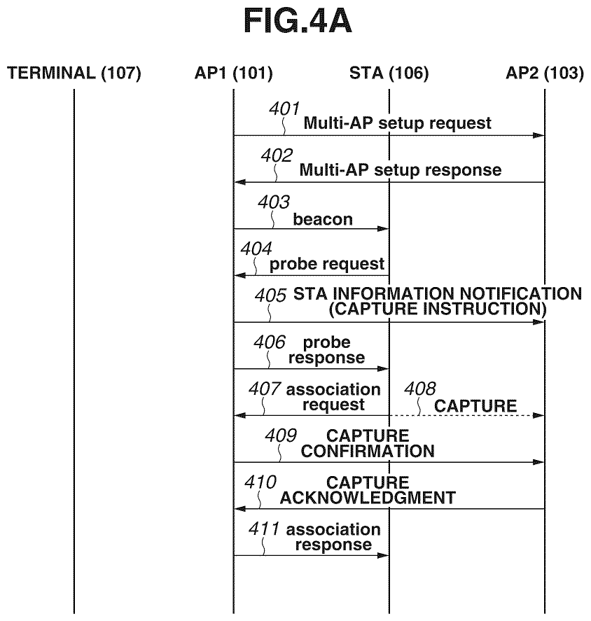

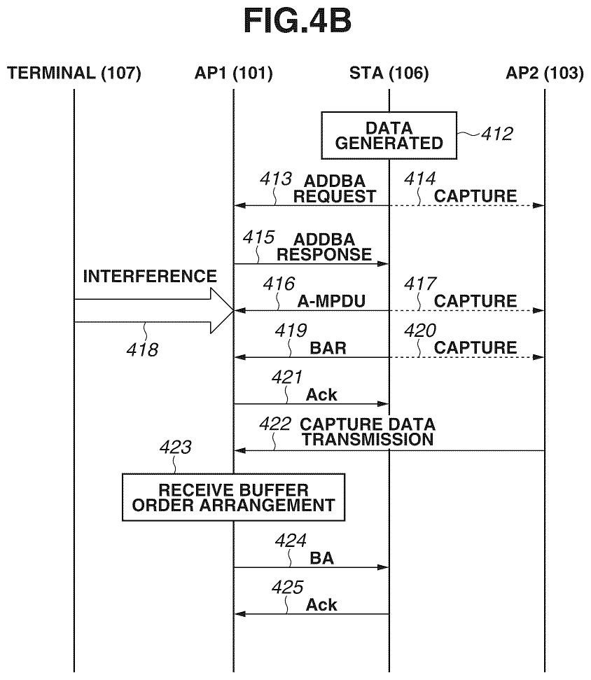

A processing sequence according to a first embodiment will be described below with reference to FIGS. 4A and 4B.

Referring to FIG. 4A, in step 401, the AP1 101 transmits a Multi-AP setup request to the AP2 103.

In step 402, the AP2 103 transmits a Multi-AP setup response to the AP1 101.

In steps 401 and 402, a plurality of APs collaboratively performs data communication. The AP1 101 serves as a Coordinator AP, and the AP2 103 serves as a Coordinated AP. The Coordinator AP is the entity that controls the Multi-AP configuration and operations. The Coordinator AP performs collaborative operations by sharing wireless medium resources with the other AP, and therefore may be referred to as a sharing AP. Likewise, the Coordinated AP may be referred to as a shared AP.

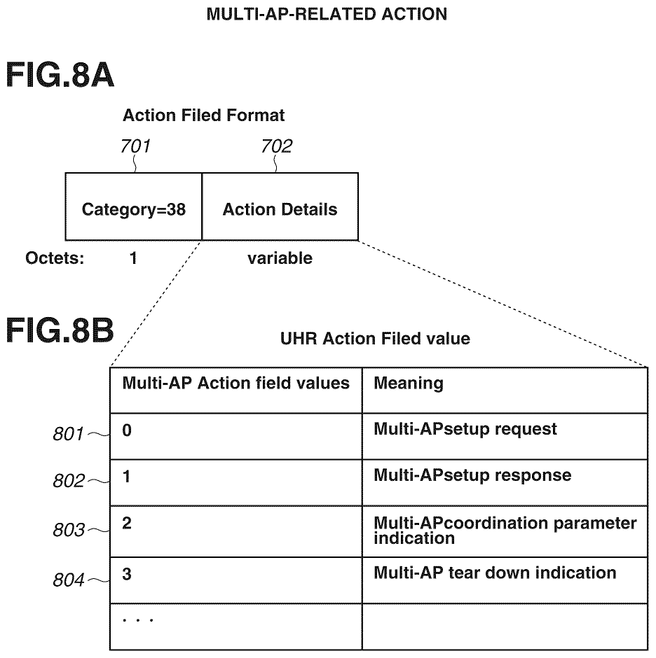

In steps 401 and 402, whether the Joint Reception processing capability is supported is checked and notified. For example, whether the Joint Reception processing capability is supported is checked based on whether a predetermined standard of the IEEE802.11 series standard is supported. Types of setup, confirmation, and notification will be described below with reference to FIGS. 8A and 8B.

In step 403, the AP1 101 issues a Beacon notification. This notification is generally broadcasted at fixed intervals, e.g., at 100-ms intervals. Management frames (a Beacon, a Probe Request/Response, and an Association Request/Response to be described below) can include various types of Information Elements (IEs) indicating Capability and Operation (management and actual operations). In the present disclosure, the AP1 101 notifies that the AP1 101 operates on the Multi-AP configuration and supports the Joint Reception capability. Each of the AP1 101 and the STA 106 includes an IE indicating supporting of the Delayed Ack capability. A Delayed Ack refers to a BA that is transmitted at a delayed timing, and the Delayed Ack capability refers to the capability of transmitting BA at a delayed timing. For example, in a case where a communication apparatus conforms to a predetermined standard of the IEEE802.11 series standard, it is determined that the apparatus supports the Delayed Ack capability.

In step 404, the STA 106 transmits a Probe Request to the AP1 101. The STA 106 may transmit a Probe Request that includes information indicating whether the STA 106 has the Delayed Ack capability.

In step 405, the AP1 101 issues to the AP2 103 a capture instruction notifying that the STA 106 is the capture target. “Capture” refers to, when a frame from a non-connection terminal is received, storing the received frame so that the frame can be transmitted to the other AP at least at the Media Access Control (MAC) level. “Capture” is sometimes referred to as “snoop”. This notification is performed by a Multi-AP coordination parameter indication 803 (described below). As an example of capture, the AP2 103 receives a frame transmitted from the STA 106 not having established communication with the AP2 103. The AP2 103 transmits the stored frame to the AP1 101. Examples of non-connection states include a state where no Association Request/Response is exchanged and a state where the 4-way Handshake processing is not performed. The capture instruction enables the AP1 101 and the AP2 103 to collaboratively receive the data transmitted by the STA 106.

In step 406, the AP1 101 returns a Probe Response to the STA 106.

In step 407, the STA 106 transmits an Association Request to the AP1 101.

In step 408, the AP2 103 captures the frame transmitted in step 407.

In step 409, the AP1 101 transmits to the AP2 103 a confirmation signal indicating whether the frame from the STA 106 has been captured.

In step 410, the AP2 103 transmits a capture acknowledgment to the AP1 101. In a case where the AP2 103 has received the Association Request transmitted in step 407, the AP2 103 returns an acknowledge to the AP1 101. In a case where the AP2 103 has not received the Association Request, the AP2 103 returns a negative acknowledge to the AP1 101.

In step 411, the AP1 101 returns an Association Response to the STA 106.

Then, the AP1 101 and the STA 106 perform 4-way Handshake according to the encryption setting. Accordingly, the AP1 101 and the STA 106 share Pairwise Master Key (PMK), and the AP1 101 generates Group Temporal Key (GTK). According to the present disclosure, the AP2 103 neither shares nor stores these encryption keys.

Through the above-described procedure, an environment where the AP1 101 and the AP2 103 are to perform Joint Reception based on the Delayed Ack capability of the STA 106 is established.

The Delayed Ack capability to be used for the Joint Reception processing is based on the HT-delayed Block Acknowledgment capability or a new Capability defined for a successor standard of the IEEE802.11be standard. The Delayed Ack capability is implemented by the use of a mechanism for transmitting BA defined by the IEEE802.11 series standard, at a delayed timing.

Step 412 and subsequent steps in FIG. 4B (procedures after step 411) are procedures for data transmission from the STA 106 to the AP1 101.

In step 412, communication data is generated in the STA 106.

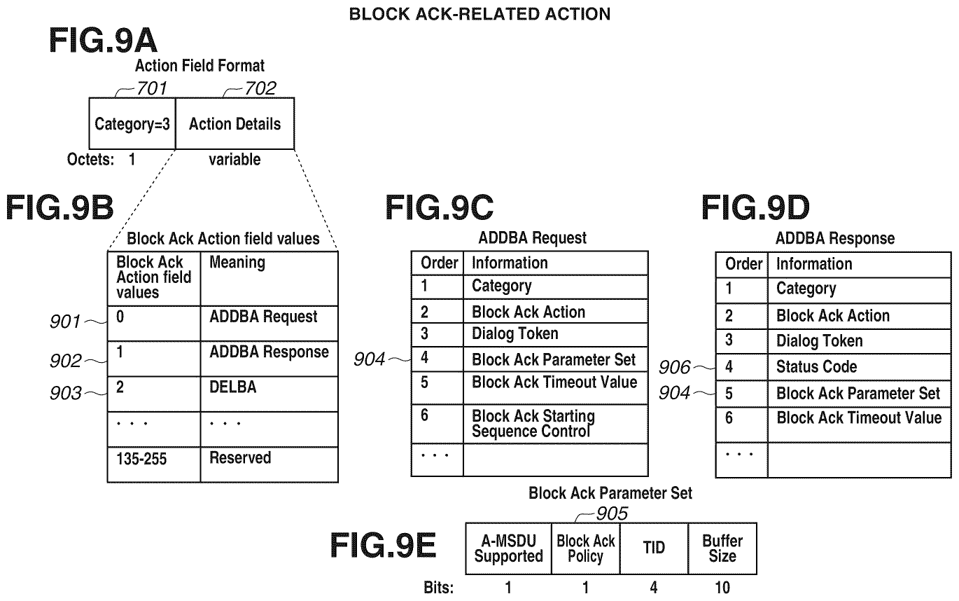

In step 413, the STA 106 transmits an Add Block Ack (ADDBA) Request to the AP1 101. The ADDBA refers to a procedure of a reception response to a plurality of frame transmissions, with which BA-related settings are performed. The ADDBA is defined in an Action frame illustrated in FIGS. 9A to 9E. More specifically, the STA 106 transmits an ADDBA Request to the AP1 101 to request the AP1 101 to perform processing for transmitting a BA at a delayed timing, i.e., transmitting the Delayed Ack.

In step 414, the AP2 103 captures the ADDBA Request transmitted in step 413.

In step 415, the AP1 101 sets a Block Ack Policy bit 905 of the ADDBA Response frame to “0” (zero) and returns the ADDBA Response frame to the STA 106. In this case, a Status Code 906 is “SUCCESS”. Thus, the Block Acknowledgment procedure using the Delayed Ack is to be applied in data exchange between the STA 106 and the AP1 101.

In step 416, the STA 106 transmits the data generated in step 402 in the Aggregate Medium access control Protocol Data Unit (A-MPDU) format. Although not illustrated, the AP1 101 starts an inactivity timer upon reception of the A-MPDU. When this timer times out (expired), the ADDBA procedure established in steps 413 and 414 is terminated (Deleted).

In step 417, the AP2 103 captures the A-MPDU transmitted in step 416.

In step 418, an interference electric wave of the terminal 107 is generated. This electric wave affects the frame reception of the AP1 101. In this case, the electric wave affects the reception of the A-MPDU transmitted in step 416.

In step 419, the STA 106 transmits a Block Acknowledgment Request (BAR) to the AP1 101.

In step 420, the AP2 103 captures the BAR transmitted in step 419.

In step 421, the AP1 101 transmits an Ack (normal Ack) to the STA 106 to notify the STA 106 of the BAR reception. In this case, the AP1 101 can return an Ack, not a Block Acknowledgment (BA), since the Block Ack Policy bit 905 is set to “0” (zero) in step 415.

In step 422, the AP2 103 transmits the payload of the A-MPDU captured in step 417 to the AP1 101. The payload refers to a Medium access control Service Data Unit (MSDU) group at the MAC layer level. The AP2 103 transmits the payload via the DS 105 in step 422.

In step 423, the AP1 101 arranges the A-MPDU data received in step 416 and the data received in step 422 in order of the sequence number to integrate these pieces of data.

In step 424, the AP1 101 generates a Block Acknowledgment (BA) based on the processing in step 423 and transmits the BA to the STA 106. More specifically, the Delayed Ack processing enables the timing of the BA for the A-MPDU transmitted in step 416 to be delayed from the timing immediately after step 416 to the timing of step 424. In step 425, the STA 106 transmits an Ack to the AP1 101.

By the processing in steps 412 to 425, a series of processing for the A-MPDU transmission is completed. However, in a case where the STA 106 still has data to be transmitted, the STA 106 performs the processing from step 416. Alternatively, the STA 106 may change a Block Ack parameter and then perform the processing from step 413.

As described above, in a case where the AP1 101 responds to the STA 106 in response to the data collaboratively received by a plurality of APs, the AP1 101 is able to appropriately perform processing to respond to the data transmission by delaying the BA transmission to the STA 106.

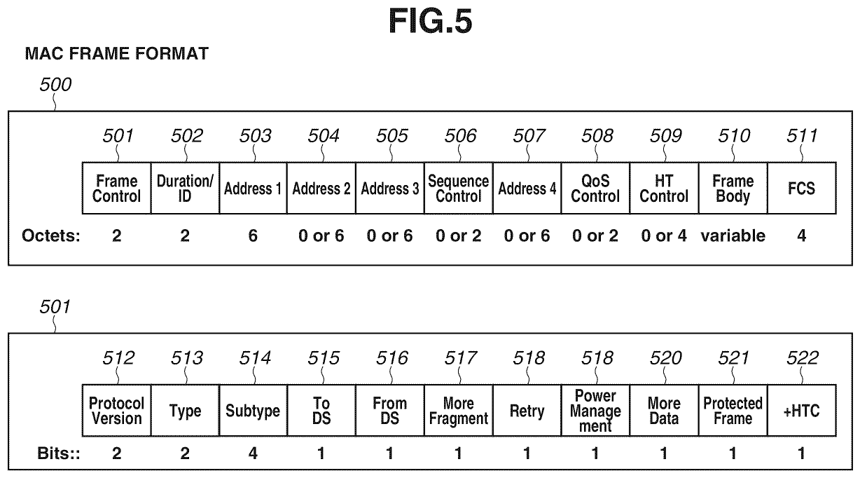

FIG. 5 is a diagram illustrating a MAC frame format conforming to the IEEE802.11 standard. The MAC frame includes a MAC frame 500 as an entire frame. In common descriptions, Octets and Bits indicate the size of each field. A field indicated as “variable” means that the field has a variable length.

The MAC frame includes a Frame Control field 501 including subfields 512 to 522.

A Duration field 502 has a 2-octet (16-bit) length. When the Duration field 502 indicates the frame length or time such as TXOP, Most Significant Bit (MSB: B15) is “1” and the remaining 15 bits indicate 0 to 32,767 microseconds.

The MAC frame includes an Address1 field 503, an Address2 field 504, an Address3 field 505, and an Address4 field 507. A Basic Service Set Identifier (BSSID) and the source and destination addresses are set with the Type subfield 513 and the Subtype subfield 514 of the MAC frame. The Address field to be used depends on the Type subfield 513.

The MAC frame includes a Sequence Control field 506.

The MAC frame includes a QoS Control field 508. A Buffer Status Report (BSR) of the standard earlier than the IEEE802.11ax standard is included in the QoS Control field 508 as two different pieces of information.

The MAC frame includes an HT Control field 509.

The MAC frame includes a Frame Body field 510. In a case in which the Type subfield 513 indicates the management frame, more specifically, in a case of a Beacon and a Probe Request/Response, various types of Information Element (IE) are disposed at this field position.

The MAC frame includes a Frame Check Sequence (FCS) field 511.

The Protocol Version subfield 512 is represented by a 2-bit number and 0 is set to the subfield in the case of an IEEE802.11 frame.

The Type subfield 513 is represented by a 2-bit number and indicates Management, Control, or Data.

The Subtype subfield 514 is represented by a 4-bit number and classifies the types of Management, Control, and Data into sub types.

The “To DS” subfield 515 is represented by a 1-bit number and indicates that the frame destination is Distribution System (DS).

The “From DS” subfield 516 is represented by a 1-bit number.

The “More Fragment” subfield 517 is represented by a 1-bit number.

The Retry subfield 518 is represented by a 1-bit number.

The Power Management subfield 519 is represented by a 1-bit number.

The “More Data” subfield 520 is represented by a 1-bit number.

The Protected Frame subfield 521 is represented by a 1-bit number.

The +HTC subfield 522 is represented by a 1-bit number.

Frames in which the +HTC bit is able to be set, i.e., frames that is able to include the HT Control field include the QoS Data, Management, and RTS frames. More specific conditions apply, but descriptions of more detailed conditions will be omitted.

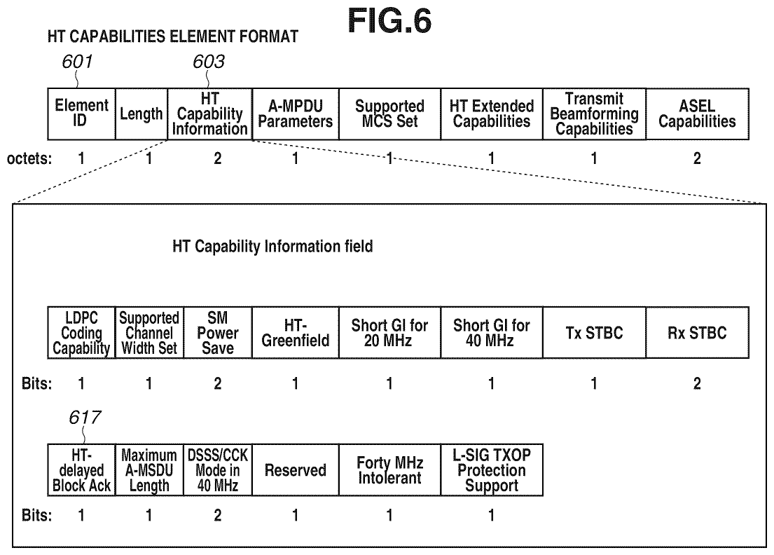

FIG. 6 is a diagram illustrating the HT Capabilities element including eight different fields. This element is included in Management frames of, for example, a Beacon, a Probe Request/Probe Response, and an Association Request/Association Response.

An Element ID field 601 has a value of 45. For simplification of descriptions, fields related to the present embodiment will be assigned reference numerals. Descriptions of fields assigned no reference numerals will be omitted.

An HT Capability Information field 603 has a 2-octet length.

An HT-delayed Block Acknowledgment 617 has a 1-bit length. With the APs and STA according to the present disclosure having the bit set to “1”, supporting of the capability of transmitting the Delayed Ack to the BAR, i.e., the capability of handling the procedure not returning an Immediate BA. According to the present embodiment, this bit is also used by the AP1 101 to determine whether the STA 106 supports the Joint Reception operation.

When the Delayed Ack capability is indicated by the UHR Capabilities element, the AP1 101 will determine the capability based on a similar element to the element in FIG. 6.

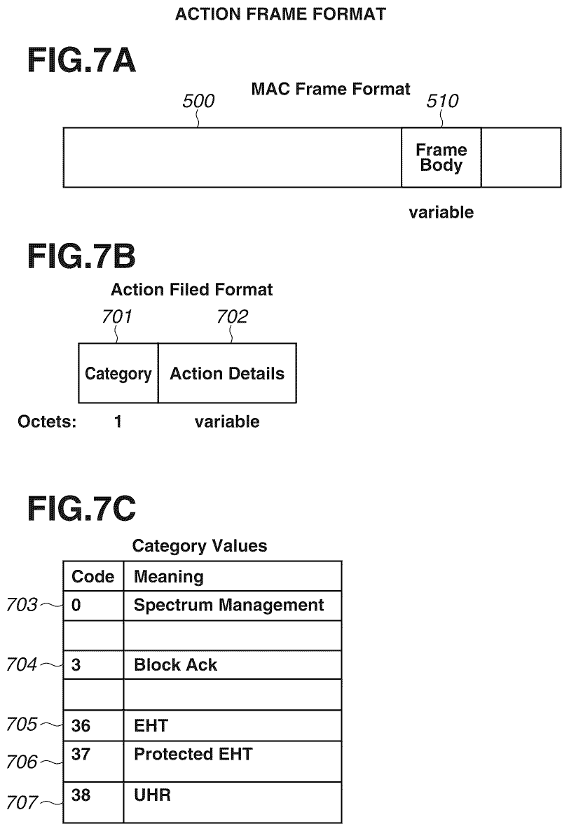

FIGS. 7A and 7B are diagrams each illustrating Action frame formats.

The Action frame is a type of a Management frame, and in the Frame Control field 501 (2 octets) of the MAC frame, the Type subfield 513 (B3−B2) is “00” and the Subtype subfield 514 (B7−B4) is “1101”.

The frame body of the Action frame includes a Category field 701 (1 octet) and “Action Details” field 702 (variable length).

As illustrated in FIG. 7C, the Category field 701 indicates the Meaning of the Action. At present, the IEEE802.11be Draft2.3 standard defines values from 0 “Spectrum Management” 703 to 37 “Protected EHT” 706 as values (Codes) of the Category field 701. For example, the values include a Code 3 “Block Ack” 704 and a Code 36 “EHT” 705. For an Action Frame related to the Block Ack (described below), the Category field 701 is “3”. This embodiment additionally defines a Code 38 “UHR” 707. The “Action Details” field 702 is specified for each Category field 701.

The present embodiment executes the procedure related to a Multi-AP by adding an Action of an EHT Protected Category or defining a Category for a new UHR. The Multi-AP refers to a form in which a plurality of APs collaboratively performs data communication.

FIG. 8A illustrates an Action frame format related to a Multi AP. This example is the UHR (Category=38) frame. FIG. 8B illustrates the value and meaning of “Multi-AP Action field values”. The communication apparatus sets a suitable value and transmits it.

The value 0 of “Multi-AP Action field values” indicates that the frame is a “Multi-AP setup request” 801. This frame is an Action to be transmitted to the Coordinated AP candidate when the Coordinator AP establishes a Multi-AP.

The value 1 indicates that the frame is a “Multi-AP setup response” 802 as a response to the frame 801. Exchanging the frames corresponding to the frames 801 and 802 enables the negotiation for determining the roles of the Coordinator AP and the Coordinated AP.

The value 2 indicates that the frame is the “Multi-AP coordination parameter indication” 803 as an Action of the Coordinator AP for notifying of the update of the collaborative operation parameter. Examples of collaborative operation methods include Joint Transmission (JTX), null steering, and Coordinated Orthogonal Frequency Division Multiple Access (OFDMA) in addition to Joint Reception according to the present embodiment.

Detailed parameters for the Joint Reception processing include the MAC address and the operating frequency band (2.4/5/6 GHZ) of the target STA terminal.

The value 3 indicates that the frame is a “Multi-AP tear down indication” 804 as an Action of the Coordinator AP or the Coordinated AP for notifying of the end of the Multi-AP collaborative operation.

When performing a series of the Multi-AP procedures via the DS 105, frame formats, such as Ethernet®, telephone lines, LTE, and WiMAX will be used. Even in such a case, the concept of the MAC layer (layer 2) has the same format as that in FIGS. 8A and 8B.

FIGS. 9A to 9E are diagrams illustrating an Action frame related to a Block Acknowledgment. FIG. 9A illustrates an Action Field Format with Category=“3”.

FIG. 9B illustrates the field value and respective meaning of “Block Ack Action field values”.

The value 0 indicates an “ADDBA Request” 901, and the value 1 indicates an “ADDBA Response” 902. These fields are used to make a negotiation about how the Block Ack processing is to be performed.

The value 2 indicate a “DELBA” 903 that is used to indicate discontinuation of the Block Ack procedure.

FIG. 9C illustrates an ADDBA Request, i.e., information that is included in a case of the ADDBA Request frame. FIG. 9D illustrates an ADDBA Response, i.e., information that is included in a case of the ADDBA Response frame.

An Order 4 of ADDBA request or Order 5 of ADDBA Response indicates a “Block Ack Parameter Set” 904 as information included in the ADDBA Request or the ADDBA Response frame, respectively.

FIG. 9E illustrates details of the “Block Ack Parameter Set” 904. The “Block Ack Parameter Set” 904 includes the Block Ack Policy field 905. The value 1 of this bit indicates that the frame is an Immediate Block Ack, the value 0 thereof indicates that the frame is a Delayed Block Ack, and this bit is used for the negotiation about a BA. In a case of the Immediate Block Ack, the AP1 101 immediately returns the BA upon reception of data, and in a case of the Delayed Block Ack, the AP1 101 returns the BA at a delayed timing after reception of data.

An Order 4 of ADDBA Response indicates a 2-octet “Status Code” 906 as Information included in the ADDBA Response. The value 0 indicates that the frame is an acknowledgment in response to the ADDBA Request.

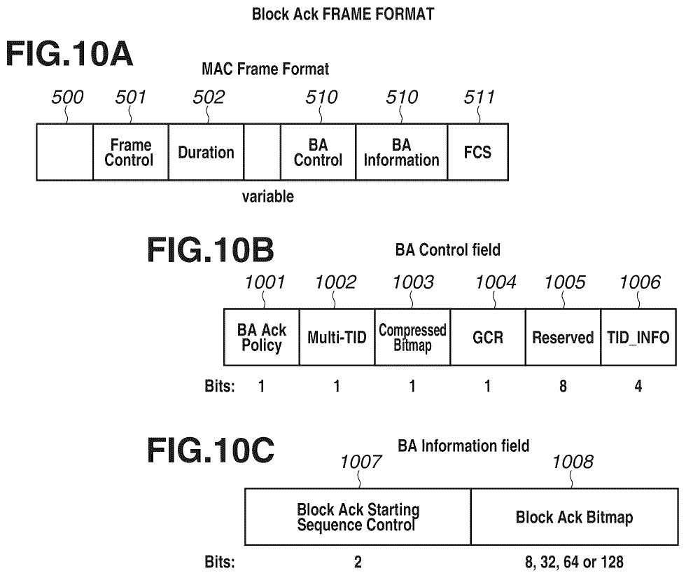

FIGS. 10A to 10C are diagrams illustrating the configurations of the Block Ack Request and the Block Ack frames. FIG. 10A illustrates the entire configuration of the Block Ack Request and the Block Ack frames. The frame includes the Frame Control field 501, the Duration field 502, two Addresses (Receiver Address and Transmitter Address (not illustrated)), the Frame Body fields 510 (BA Control and BA Information), and the FCS field 511.

FIG. 10B illustrates the configuration of a BA Control field. The BA Control field includes a BA Ack Policy subfield 1001, a Multi-TID subfield 1002, a Compressed Bitmap subfield 1003, a GCR subfield 1004, a Reserved subfield 1005, and a TID_INFO subfield 1006.

FIG. 10C illustrates the BA Information field including a Block Ack Starting Sequence Control subfield 1007 and a Block Ack Bitmap subfield 1008. The Block Ack Starting Sequence Control subfield 1007 and the Block Ack Bitmap subfield 1008 indicate which Medium Access Control Service Data Unit (MSDU) is received. According to the present embodiment, the BA frame itself is based on the prior art and redundant descriptions thereof will be omitted.

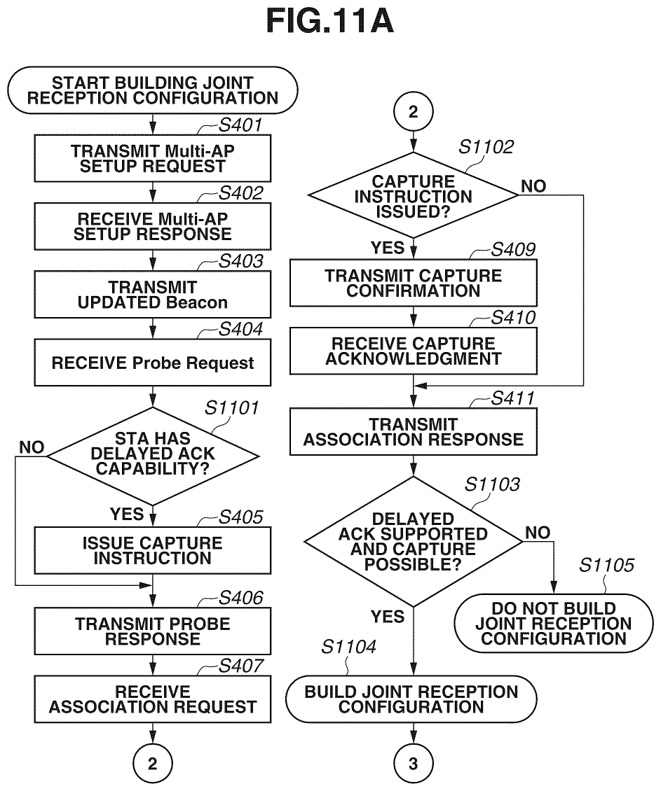

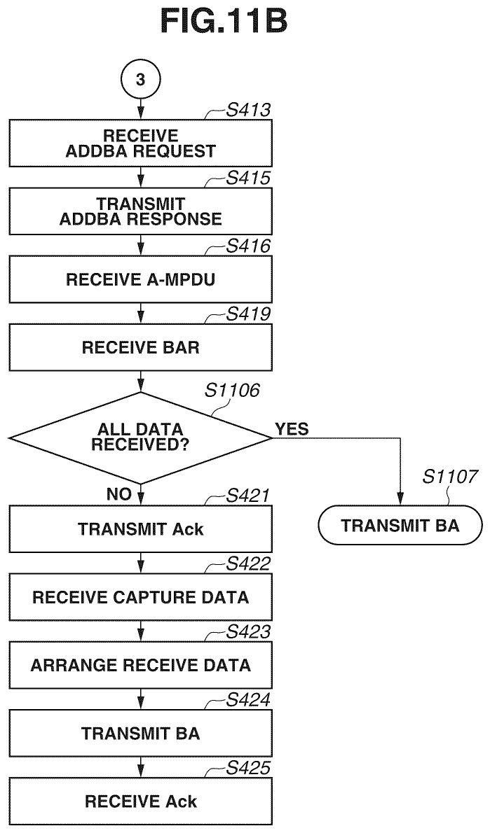

FIGS. 11A and 11B are a flowchart illustrating Multi-AP settings and Joint Reception processing performed by the AP1 101, i.e., processing performed by the Coordinator AP. This flowchart is implemented, for example, when at least one processor executes programs stored in at least one memory. For each piece of processing of the AP corresponding to each step of the sequence in FIGS. 4A and 4B, the letter “S” precedes the same step number. For example, the processing of the AP corresponding to step “401” in the sequence in FIG. 4A is represented as step “S401” in the flowchart in FIGS. 11A and 11B.

In step S401, the AP1 101 transmits a Multi-AP setup request to the AP2 103. In step S402, the AP1 101 receives the Multi-AP setup response from the AP2 103.

In step S403, the AP1 101 transmits beacons including various IEs. In step S404, the AP1 101 receives the Probe Request from the STA 106.

In step S1101, the AP1 101 determines whether the STA 106 having transmitted the Probe Request supports the Delayed Ack capability. For example, the AP1 101 determines whether the STA 106 supports the Delayed Ack capability, based on the information included in the received Probe Request. In a case where the STA 106 supports the Delayed Ack capability (YES in step S1101), the processing proceeds to step S405. In a case where the STA 106 does not support the Delayed Ack capability (NO in step S1101), the processing proceeds to step S406.

In step S405, the AP1 101 notifies the AP2 103 that the STA 106 is the capture target. For example, the AP1 101 issues a notification by using the parameter of the “Multi-AP coordination parameter indication” 803 in FIG. 8B.

In step S406, the AP1 101 transmits a Probe Response in response to the Probe Request received in step S404. In step S407, the AP1 101 receives the Association Request.

In step S1102, the AP1 101 checks whether a capture instruction has been issued to the Coordinated AP. In a case where the relevant instruction has been issued (YES in step S1102), the processing proceeds to step S409. In a case where the capture instruction has not been issued (NO in step S1102), the processing proceeds to step S411.

In step S409, the AP1 101 transmits to the AP2 103 a confirmation signal for checking whether the AP2 103 has captured the frame from the STA 106.

In step S410, the AP1 101 receives from the AP2 103 a capture acknowledgment as a response to the confirmation signal transmitted in step S409.

In step S411, the AP1 101 returns to the STA 106 an Association Response as a response to the Association Request received in step S407. In a case where the STA 106 supports the Delayed Ack and the AP2 103 is able to capture the frame of the STA 106 in Association with the AP2 103 (YES in step S1103), the processing proceeds to step S1104. In a case where the conditions are not met (NO in step S1103), the processing proceeds to step S1105.

In step S1104, the AP1 101 establishes a connection with the STA 106. In this case, a configuration for the Joint Reception processing is built.

In step S1105, the AP1 101 establishes a connection with the STA 106. In this case, a configuration for performing the Joint Reception processing is not built.

In step S413, the AP1 101 receives an ADDBA Request from the STA 106. In step S415, the AP1 101 returns an ADDBA Response frame to the STA 106.

In step S416, the AP1 101 receives an A-MPDU from the STA 106.

In step S419, the AP1 101 receives a BAR from the STA 106.

In step S1106, the AP1 101 determines whether the AP1 101 has acquired all data of the A-MPDU received from the STA 106 in step S416. In a case where all data has been acquired (YES in step S1106), the processing proceeds to step S1107. In step S1107, the AP1 101 transmits a BA to the STA 106. In a case where part of data has not been acquired because of electronic jamming (NO in step S1106), the processing proceeds to step S421.

In step S421, the AP1 101 notifies the STA 106 of the receipt of the BAR by transmitting an Ack (normal Ack).

In step S422, the AP1 101 receives the payload of the A-MPDU captured from the AP2 103.

In step S423, the AP1 101 arranges the A-MPDU data received in step S416 and the data received in step S422 in order of the sequence number to integrate these pieces of data.

In step S424, the AP1 101 generates a Block Acknowledgment (BA) based on the processing in step S423 and transmits the BA to the STA 106. In step 425, the AP1 101 receives an Ack from the STA 106.

### Second Embodiment

According to the first embodiment, the AP1 101 receives all of the data captured by the AP2 103 in step S422. A second embodiment will be described below centering on an example where the AP1 101 acquires from the AP2 103 only the data not having been received from the STA 106, to reduce the amount of communication data. The present embodiment has a similar basic configuration to the first embodiment, and only differences will be described below.

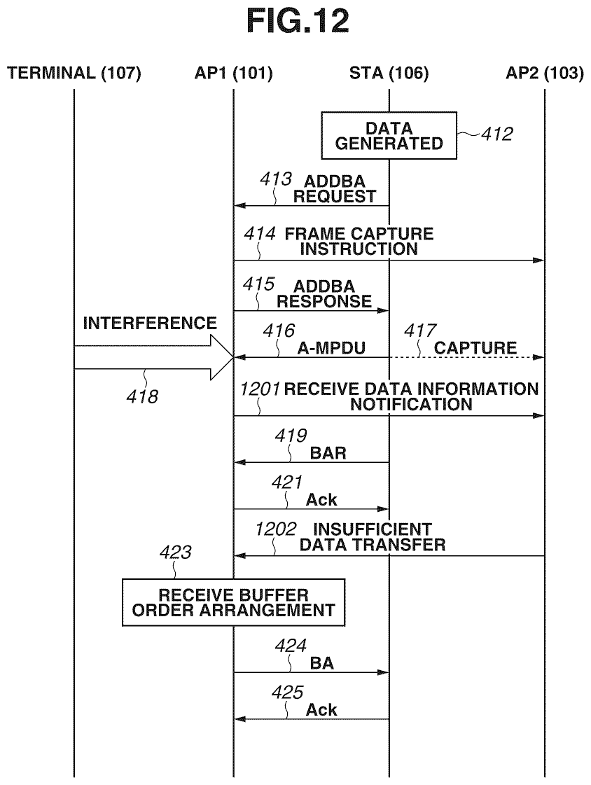

FIG. 12 is a sequence diagram illustrating processing according to the present embodiment. The basic configuration is similar to that in FIG. 4B, and only differences will be described below.

In step 1201 as a timing between steps 416 and 419 according to the first embodiment, the AP1 101 transmits receive data information (data received by the AP1 101 itself) to the AP2 103. Examples of the receive data information include the MSDU sequence number in the A-MPDU received in step 416.

In step S1202, instead of the processing in step 422 according to the first embodiment, the AP2 103 transmits to the AP1 101 missing data not having been received by the AP1 101, based on the receive data information received in step S1201.

This configuration has an effect of reducing the amount of data to be transmitted from the AP2 103 to the AP1 101 in comparison with the first embodiment.

Although, in the present embodiment, the AP1 101 transmits a normal Ack in step 421, the AP1 101 may transmit a BA for the data received in step 416. In this case, the AP2 103 may detect missing data by capturing the BA for the received data. In a case where the AP1 101 is configured to transmit a BA, not a normal Ack, in step 421, two different BAs will be communicated for one A-MPDU. Thus, when implementing this configuration, settings for two-step BA communication is to be performed in advance between the AP1 101 and the STA 106. For example, two-step BA communication to be performed is set in advance between the AP1 101 and the STA 106 at the time of the negotiation using the Delayed Ack capability of the UHR Capabilities element.

### Other Embodiments

A recording medium storing the program code of software that realizes the above functions may be supplied to a system or device, and the computer (CPU, MPU) of the system or device may read and execute the program code stored in the recording medium. In this case, the program code read from the recording medium itself realizes the functions of the above-described embodiments, and the recording medium storing the program code constitutes the above-described device.

As the recording medium for supplying the program code, various types of media can be used, such as flexible disks, hard disks, optical disks, magneto-optical disks, CD-ROMs, CD-Rs, magnetic tapes, non-volatile memory cards, ROMs, DVDs, and others.

In addition to realizing the above functions by executing the program code read by the computer, the operating system (OS) running on the computer may perform part or all of the actual processing based on the instructions of the program code, thereby realizing the above functions.

Furthermore, the program code read from the recording medium may be written into the memory provided in an expansion board inserted into the computer or an expansion unit connected to the computer. Based on the instructions of the program code, the CPU provided in the expansion board or expansion unit may perform part or all of the actual processing, thereby realizing the above functions.

The present disclosure enables appropriate communication processing when a plurality of communication apparatuses collaboratively performs data communication.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems an optical disk (such as a compact disc (CD), digital versatile disc (DVD), or Blu-ray Disc™ (BD)), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A communication apparatus which communicates with a first other communication apparatus and a second other communication apparatus, the communication apparatus comprising:
one or more memories that store a set of instructions; and
at least one processor, wherein the communication apparatus is caused, by the at least one processor executing the instructions, to perform operations comprising:
performing first settings to receive data in collaboration with the first other communication apparatus;
performing second settings with the second other communication apparatus to transmit a Block Acknowledgment (BA) at a delayed timing;
transmitting, in a case where at least part of first data transmitted from the second other communication apparatus is received, an Acknowledgment (Ack) to the second other communication apparatus; and
transmitting, in a case where at least part of the first data received by the first other communication apparatus is received from the first other communication apparatus, the BA to the second other communication apparatus after transmitting of the Ack.

2. The communication apparatus according to claim 1, wherein the first other communication apparatus is an access point apparatus, and the second other communication apparatus is a station apparatus.

3. The communication apparatus according to claim 1,
wherein the operations further comprises determining whether the first other communication apparatus is capable of performing data communication in collaboration with the other communication apparatus, and
wherein, in a case where the communication apparatus determines that the first other communication apparatus is capable of performing data communication in collaboration with the other communication apparatus, the communication apparatus performs the first settings to receive data in collaboration with the first other communication apparatus.

4. The communication apparatus according to claim 1,
wherein the operations further comprises determining whether the second other communication apparatus is capable of communicating the BA at a delayed timing, and
wherein, in a case where the communication apparatus determines that the second other communication apparatus is capable of communicating the BA at a delayed timing, the communication apparatus performs settings with the second other communication apparatus to transmit the BA at a delayed timing.

5. The communication apparatus according to claim 1, wherein the first other communication apparatus and the second other communication apparatus establish no communication connection to each other.

6. The communication apparatus according to claim 1, wherein the communication apparatus and the first other communication apparatus are connected to each other via a Distribution System (DS).

7. The communication apparatus according to claim 1, wherein, in a case where the first settings are performed, the first other communication apparatus receives a frame transmitted from the second other communication apparatus and stores the frame to transmit the frame.

8. The communication apparatus according to claim 1, wherein the operations further comprises transmitting, in a case where the first settings are performed, a frame for checking whether the first other communication apparatus has received a frame transmitted from the second other communication apparatus, to the first other communication apparatus.

9. The communication apparatus according to claim 1, wherein the operations further comprises integrating data transmitted from the second other communication apparatus at least part of which has been received with data transmitted from the second other communication apparatus received from the first other communication apparatus.

10. The communication apparatus according to claim 1, wherein the second settings for transmitting the BA at a delayed timing includes receiving of an Add Block Ack (ADDBA) Request and transmitting of an ADDBA Response.

11. The communication apparatus according to claim 1, wherein the communication apparatus uses Delayed Block Ack conforming to the Institute of Electrical and Electronics Engineers (IEEE)802.11 series standard to transmit the BA at a delayed timing.

12. The communication apparatus according to claim 1, wherein communication with the second other communication apparatus conforms to the IEEE802.11 series standard.

13. A communication apparatus which communicates with a first other communication apparatus and a second other communication apparatus, the communication apparatus comprising:
one or more memories that store a set of instructions; and
at least one processing circuit, wherein the communication apparatus is caused, by the at least one processing circuit executing the instructions and/or the at least one processing circuit itself operating, to perform operations comprising:
performing first settings to receive data in collaboration with the first other communication apparatus;
performing second settings to transmit the BA with the second other communication apparatus;
transmitting, in a case where at least part of the first data transmitted from the second other communication apparatus has been received, a first BA to the second other communication apparatus; and
transmitting, in a case where at least part of the first data received by the first other communication apparatus is received from the first other communication apparatus, a second BA to the second other communication apparatus after transmitting the first BA.

14. A control method of a communication apparatus that communicates with a first other communication apparatus and a second other communication apparatus, the method comprising:
performing first settings to receive data in collaboration with the first other communication apparatus;
performing second settings with the second other communication apparatus to transmit a BA at a delayed timing;
transmitting, in a case where at least part of first data transmitted from the second other communication apparatus has been received, an Ack to the second other communication apparatus; and
transmitting, in a case where at least part of the first data received by the first other communication apparatus is received from the first other communication apparatus, the BA to the second other communication apparatus after transmitting the Ack.

15. A non-transitory computer readable storage medium that stores a program that causes, when the program is executed, a communication apparatus to perform each of the operations according to claim 1.
